(19) United States
(12) Patent Application Publication
(10) Pub. No.: US 2012/0317815 A1
(43) Pub. Date: Dec. 20, 2012

(54) ELECTRIC SHAVER

(75) Inventors: Hiroaki Shimizu, Shiga (JP); Noboru Kobayashi, Nara (JP); Shunsuke Komori, Shiga (JP); Toshio Ikuta, Shiga (JP); Jyuzaemon Iwasaki, Shiga (JP)

(73) Assignee: PANASONIC CORPORATION, Osaka (JP)

(21) Appl. No.: 13/581,416

(22) PCT Filed: Mar. 24, 2011
(86) PCT No.: PCT/JP2011/057110

§ 371 Date: Aug. 27, 2012

(30) Foreign Application Priority Data
Mar. 26, 2010 (JP) 2010-071450

(51) Int. Cl. B26B 19/42

(52) U.S. Cl. 30/34.2

(57) ABSTRACT

Second hair lifting frames provided on the rear side in the traveling direction is arranged closer to a top than first hair lifting frames provided on the front side in the traveling direction. Accordingly, the differences in hair lifting ability between the first hair lifting frames and the second hair lifting frames can be reduced so as to lift body hair up more efficiently.

### TECHNICAL FIELD

The present invention relates to an electric shaver.

### BACKGROUND ART

Various types of electric shavers to shave body hair have been developed. Herein, an angle formed by the extending direction of body hair and a skin surface is called a hair rising angle. Although body hair at a large hair rising angle (for example, 45° to 60° is easy to shave, it is difficult to shave body hair at a small hair rising angle (for example, 30° or less), that is, lying body hair. Thus, electric shavers provided with hair lifting portions in frames of outer blades having a hair lifting ability higher than conventional hair lifting portions have been developed (for example, refer to Patent Document 1).

### CITATION LIST

### Patent Literature

Patent Document 1: Japanese Patent No. 3083548

### SUMMARY OF THE INVENTION

In the conventional electric shavers, the hair lifting frames provided with the hair lifting portions are uniformly arranged in the outer blades. Generally, outer blades are formed into an arc-like shape projecting toward the skin surface.

Therefore, during the use of such electric shavers, the skin contact surface located on the front side of the outer blade in the traveling direction on the basis of the top portion of the outer blade comes into contact with skin in a different manner from the skin contact surface located on the rear side in the traveling direction, in which a hair lifting ability of second hair lifting frames provided on the skin contact surface on the rear side tends to be lower than that of first hair lifting frames provided on the skin contact surface on the front side.

Thus, it is an object of the present invention to provide an electric shaver capable of lifting body hair up more efficiently by reducing the differences in hair lifting ability between first hair lifting frames provided on the front side and second hair lifting frames provided on the rear side, in the traveling direction on the basis of a top portion of an outer blade.

In order to solve the above-described problem, an electric shaver according to the present invention includes: a shaver main body; an outer blade having blade holes defined by frames; and an inner blade provided inside the outer blade to move relative to the outer blade and cut body hair inserted into the blade holes, wherein the outer blade is formed into an arc-like shape projecting toward a skin surface and exposed on a top end surface of the shaver main body, the frames of the outer blade include hair lifting frames provided with hair lifting portions that come into contact with the body hair to lift the body hair from the skin surface when moving on the skin surface, the hair lifting frames are uniformly formed into an identical shape, and include first hair lifting frames provided on a front side in a traveling direction of the shaver main body and second hair lifting frames provided on a rear side in the traveling direction based on a top portion of the outer blade, and the second hair lifting frames are arranged closer to the top portion than the firs hair lifting frames.

According to the present invention, the second hair lifting frames provided on the rear side in the traveling direction is arranged closer to the top portion of the outer blade than the first hair lifting frames provided on the front side. Accordingly, it is possible to reduce the differences in hair lifting ability between the first hair lifting frames and the second hair lifting frames so as to lift body hair up more efficiently.

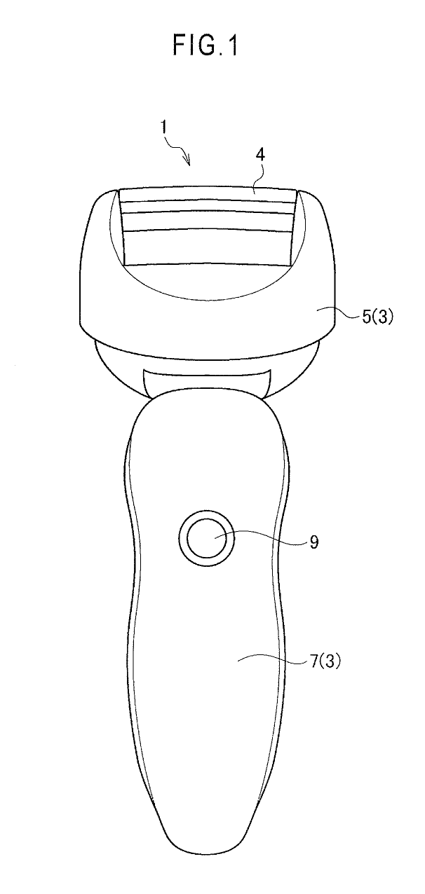

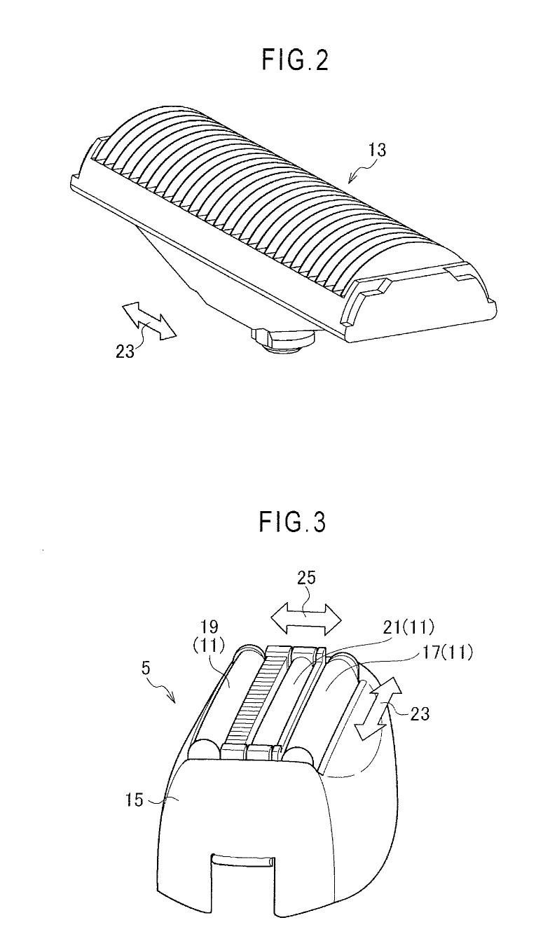

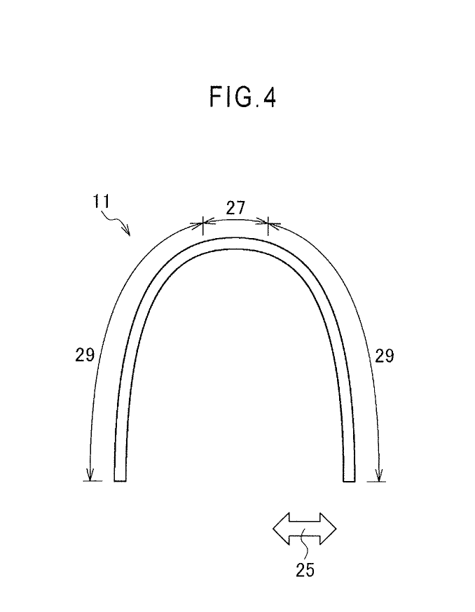

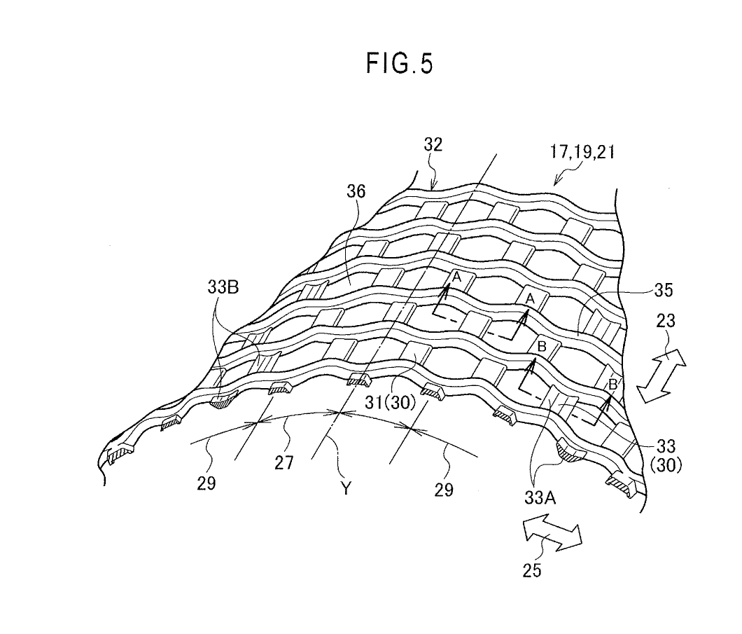

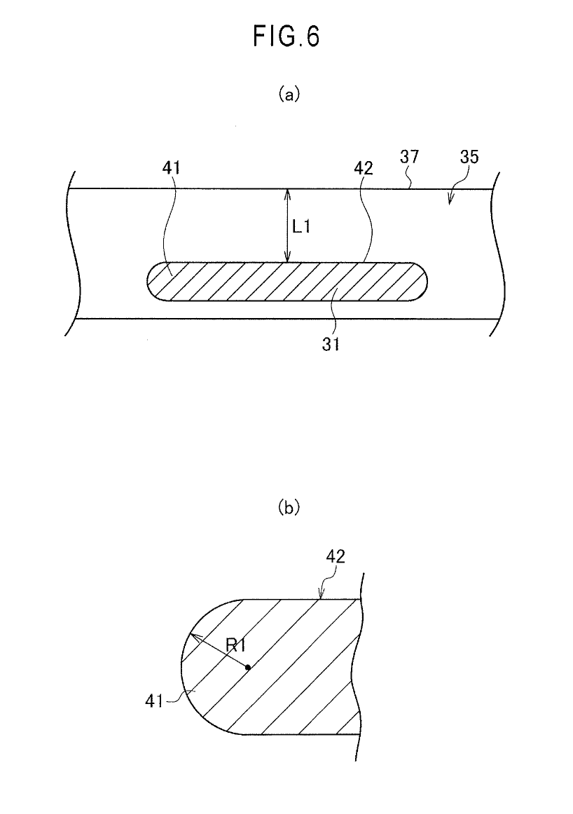

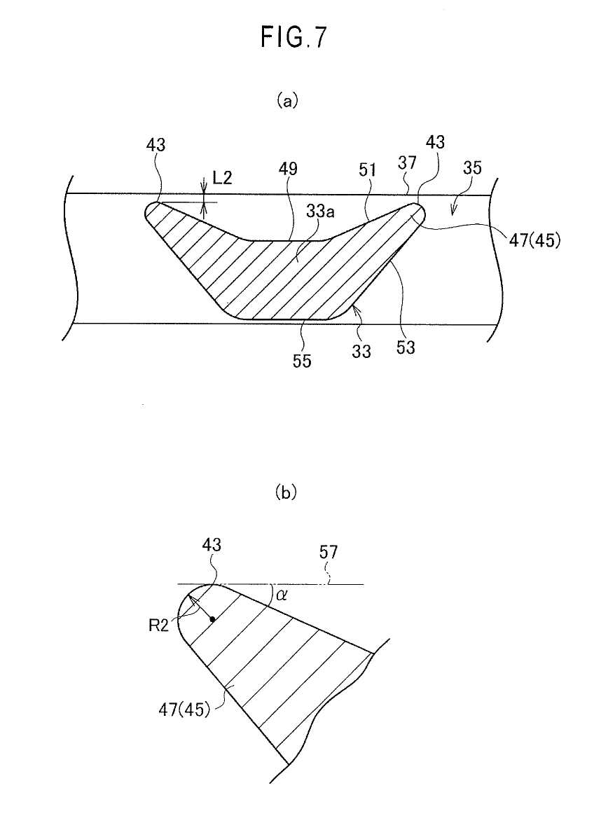

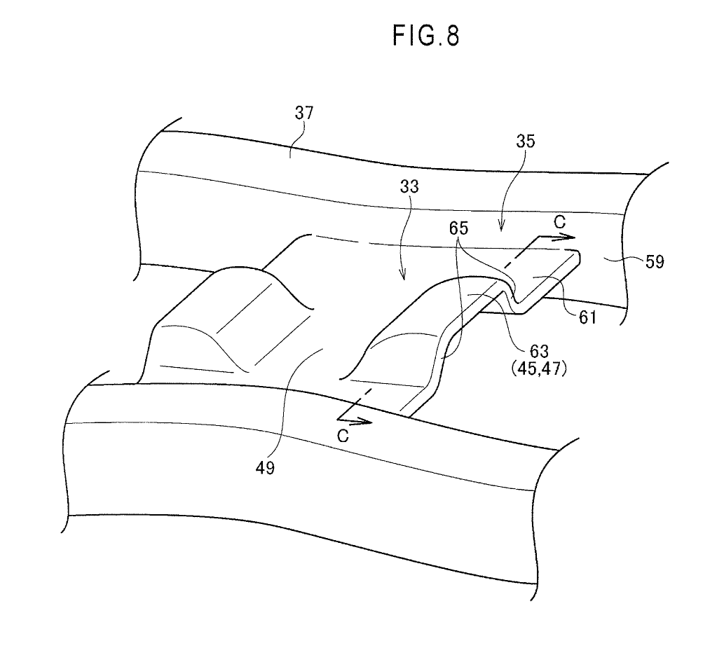

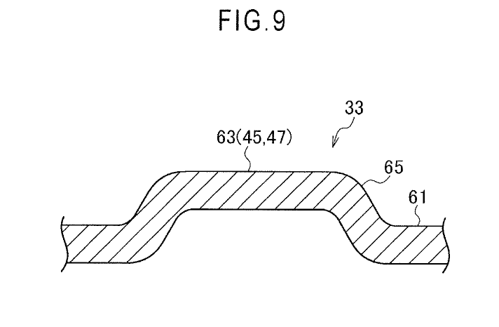

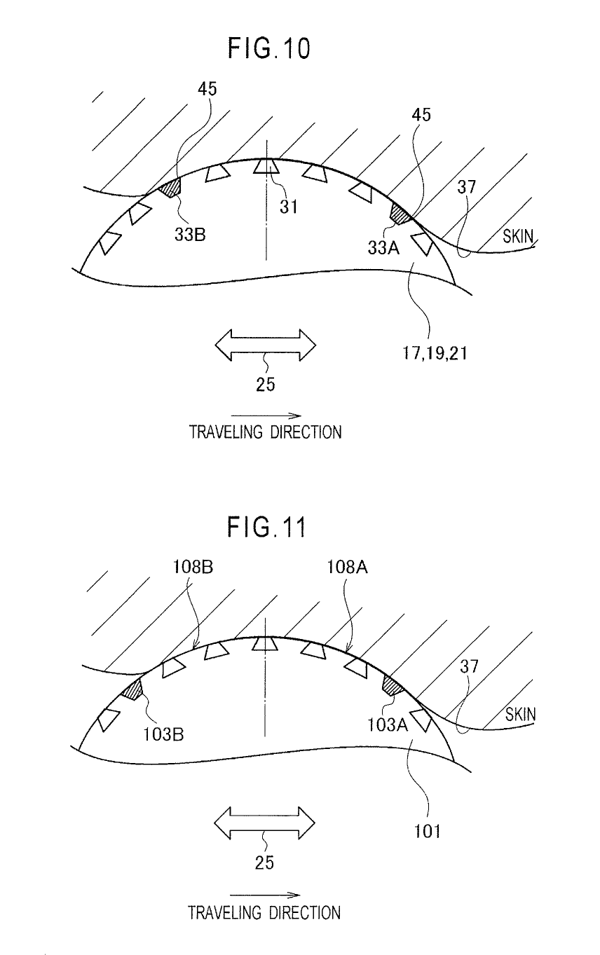

### BRIEF DESCRIPTION OF THE DRAWINGS

[FIG. 1] FIG. 1 is a front view showing an electric shaver according to an embodiment of the present invention.

[FIG. 2] FIG. 2 is a perspective view showing an inner blade of a blade unit shown in FIG. 1.

[FIG. 3] FIG. 3 is a perspective view showing a head unit of FIG. 1.

[FIG. 4] FIG. 4 is an explanatory view of an outer blade of FIG. 3.

[FIG. 5] FIG. 5 is an enlarged perspective view of a part of the outer blade of FIG. 1.

[FIG. 6] FIG. 6(a) is a cross-sectional view taken along the line A-A in FIG. 5, and FIG. 6(b) is an enlarged cross-sectional view of a short-side end portion.

[FIG. 7] FIG. 7(a) is a cross-sectional view taken along the line B-B in FIG. 5, and FIG. 7(b) is an enlarged cross-sectional view of a hair lifting portion.

[FIG. 8] FIG. 8 is an enlarged perspective view around a frame in a longitudinal direction of FIG. 7.

[FIG. 9] FIG. 9 is a cross-sectional view taken along the line C-C in FIG. 8.

[FIG. 10] FIG. 10 is an explanatory view showing a state in which the outer blade of FIG. 3 is in contact with skin.

[FIG. 11] FIG. 11 is an explanatory view showing a state in which a conventional outer blade is in contact with skin.

### DESCRIPTION OF THE EMBODIMENTS

Hereinafter, an embodiment according to the present invention will be described in detail below with reference to the drawings. FIGS. 1 to 10 are views showing an electric shaver according to the embodiment of the present invention.

As shown in FIG. 1, an electric shaver 1 according to the present embodiment is mainly composed of a shaver main body 3, a blade unit 4 provided on the top of the shaver main body 3, and a driving unit (not shown in the figure) to drive the blade unit 4.

The shaver main body 3 according to the present embodiment is divided into a grip portion 7 held by a user, and a head unit 5 connected to the upper end of the grip portion 7. The head unit 5 is provided with the blade unit 4 to remove body hair, and the grip portion 7 is provided with a push-button switch 9 to control the driving unit to operate (turn on and off) the blade unit 4.

As shown in FIGS. 2 and 3, the blade unit 4 includes outer blades 11 exposed on the top end surface of the shaver main body 3, and inner blades 13 provided inside the outer blades 11 (below the outer blades 11) and configured to reciprocate in a longitudinal direction 23.

The outer blades 11 according to the present embodiment include a first net blade 17, a second net blade 19 and a third net blade 21, which are arranged parallel to each other in a short-side direction 25 that is the traveling direction (the shaving direction) of the electric shaver 1. In particular, the first to third net blades 17, 19 and 21 extend in the longitudinal direction 23 perpendicular to the short-side direction 25. The first net blade 17 and the second net blade 19 are located on both sides (on one side and the opposite side) in the short-side direction 25, and the third net blade 21 is located between the first net blade 17 and the second net blade 19.

The first to third net blades 17, 19 and 21 composing the outer blades 11 are each formed into an arc-like shape projecting toward the skin of a user (toward the upper side in the present embodiment) as shown in FIG. 4. According to the present embodiment, the first to third net blades 17, 19 and 21 are formed into an inverted U-shape in cross-section in the short-side direction 25 each having a top portion 27 and both side surfaces 29 and 29. The inner blades 13 are formed to conform to the inner shapes of the respective net blades 17, 19 and 21.

As shown in FIG. 5, the outer blades 11 are provided with a number of blade holes 36 that introduce body hair thereinto. The inner blades 13 move relative to the outer blades 11 (reciprocate in the longitudinal direction 23) so that the inner blades 13 cut the introduced body hair in cooperation with the outer blades 11.

The blade holes 36 are defined by frames 32. In other words, the frames 32 of the outer blades 11 include transverse frames 35 extending in an inverted U-shaped manner in the short-side direction 25 and vertical frames 30 extending in the longitudinal direction 23, and the blade holes 36 are defined by the transverse frames 35 and the vertical frames 30. The blade holes 36 have the dimension sufficient to introduce body hair thereinto. Note that, in the figure, a dashed-dotted line Y is a center line (the top) passing through the middle of the top portion 27 in the short-side direction 25.

The vertical frames 30 according to the present embodiment include hair lifting frames 33 provided with hair lifting portions 45 described below, and common vertical frames 31 having a hair lifting ability lower than that of the hair lifting frames 33.

As shown in FIGS. 6(a) and 6(b), each common vertical frame 31 is formed into an approximately flat plate in cross-section. Each short-side end portion (hair lifting portion) 41 of the common vertical frame 31 is formed into a semicircular shape in cross-section having a radius of curvature of R1. The R1 is preferably 10 μm, for example. Note that a surface 37 of the transverse frame 35 is located closer to the skin than a surface 42 of the common vertical frame 31, and the vertical distance between the surface 42 of the common vertical frame 31 and the surface 37 of the transverse frame 35 is set to L1.

Meanwhile, as shown in FIG. 7(a), each hair lifting frame 33 is formed into a substantially symmetric U-shape in cross-section. A central outer surface 49 in the short-side direction is formed into a flat shape, and bent portions 47 are inclined upward and extend toward the outer surface of the outer blade 11 (in the upper direction in the figure) from the central outer surface 49. The front ends of the bent portions 47 serve as the hair lifting portions 45 formed into a tapered shape. The hair lifting portions 45 have a function to efficiently lift the body hair at a small angle to the skin surface (that is, the lying body hair)

The bent portions 47 are provided with inclined upper surfaces 51 on the upper side thereof, and provided with inclined lower surfaces 53 on the lower side thereof. That is, the respective hair lifting frames 33 are formed by the central outer surface 49, the inclined upper surfaces 51, the inclined lower surfaces 53 and a bottom surface 55. The vertical distance between each short-side end portion 43 of the bent portion 47 and the surface 37 of the transverse frame 35 is set to L2. Thus, the hair lifting frames 33 are arranged in an offset manner so as to satisfy the magnitude relation of L2<L1. The difference between L1 and L2 is preferably 10 μm, for example.

As shown in FIG. 7(b), the short-side end portion 43 of the bent portion 47 is formed into a semicircular shape in cross-section having a radius of curvature of R2. The magnitude relation between R1 and R2 is set to be R2<R1. The R2 is preferably 3 μm, for example. Here, a clearance angle α formed by the inclined upper surface 51 and a reference line 57 in the short-side direction indicated by the chain double-dotted line is set larger than the clearance angle formed by the surface 41 of the common vertical frame 31 and the reference line 57 (that is 0°) as shown in FIG. 6(a).

As shown in FIGS. 8 and 9, each longitudinal end portion 61 of the hair lifting frame 33 extends substantially linearly in cross-section from a side wall 59 of the transverse frame 35 in the longitudinal direction. Each longitudinal end portion 61 is connected to a longitudinal center portion 63 via a gently-curved boundary 65. A radius of curvature of the boundary 65 is preferably 10 μm, for example.

Thus, in the outer blades 11 according to the present embodiment, the hair lifting frames 33 have a hair lifting ability higher than that of the common vertical frames 31. In other words, although the short-side end portions 41 of the common vertical frames 31 also have a function to lift the body hair, the hair lifting portions 45 of the hair lifting frames 33 can lift the lying body hair up more efficiently.

Therefore, the outer blades 11 according to the present embodiment can lift the body hair at a small hair rising angle (for example, 30° or less) efficiently due to the hair lifting frames 33 having the hair lifting ability higher than the common vertical frames 31. However, as described above, the outer blades 11 are formed into an arc-like shape projecting toward the skin surface. Thus, in the case in which first hair lifting frames provided on the front side in the traveling direction and second hair lifting frames provided on the rear side in the traveling direction on the basis of the top Y of the respective outer blades 11 are uniformly arranged in the outer blades 11, the hair lifting ability of the second hair lifting frames tends to be decreased.

That is, as shown in the conventional case of FIG. 11, when sliding the electric shaver 1, a user usually moves an outer blade 101 in the traveling direction while pressing a skin contact surface 108A on the front side of the outer blade 101 in the traveling direction against a skin surface 37. Therefore, the contact area of the skin contact surface 108A on the skin surface 37 is larger than the contact area of a skin contact surface 108B on the skin surface 37. When a first hair lifting frame 103A and a second hair lifting frame 103B are arranged equally (namely, symmetrically on the basis of the top Y), the second hair lifting frame 103B may have trouble coming into contact with the skin surface 37 sufficiently because the second hair lifting frame 103B is provided on the skin contact surface 108B having the smaller contact area. As a result, a hair lifting portion of the second hair lifting frame 103 does not come into contact with (is not pressed to) the skin surface 37 sufficiently and thus, the hair lifting ability of the second hair lifting frame 103B is decreased compared with the first hair lifting frame 103A.

Thus, according to the present embodiment, as shown in FIG. 10, the second hair lifting frame 33B provided on the rear side in the traveling direction is arranged closer to the top Y of the outer blade 11 than the first hair lifting frame 33A.

Due to the arrangement of the second hair lifting frames 33B closer to the top Y of the respective outer blades 11 than the first hair lifting frames 33A, the hair lifting portions 45 of the second hair lifting frames 33B can easily come into contact with the skin surface 37 compared to the case in which the first hair lifting frames 33A and the second hair lifting frames 33B are symmetrically arranged. Accordingly, the differences in hair lifting ability between the first hair lifting frame 33A and the second hair lifting frame 33B can be reduced, so as to lift the body hair up more efficiently.

According to the present embodiment, all the first to third net blades 17, 19 and 21 have the above-described feature (the arrangement of the second hair lifting frames 33B closer to the top Y of the respective outer blades 11 than the first hair lifting frames 33A). In the use of the electric shaver 1 having the above-described feature, it is preferable to indicate the traveling direction, for example, on a frame 15 of the head unit 5 (refer to FIG. 3). In the present embodiment, the first and second hair lifting frames 33A and 33B are arranged in an offset manner in the longitudinal direction 25 as shown in FIG. 5 in order to enhance the hair lifting effect by the hair lifting frames 33. However, the first and second hair lifting frames 33A and 33B may be provided linearly instead of the offset arrangement.

As described above, according to the electric shaver 1 of the present embodiment, the frames 32 of the outer blades 11 include the hair lifting frames 33 provided with the hair lifting portions 45 that come into contact with the skin surface 37 to lift the body hair from the skin surface 37 when moving on the skin surface, and the hair lifting frames 33 include the first hair lifting frames 33A and the second hair lifting frames 33B having the identical shape. In addition, the second hair lifting frames 33B, which are provided on the rear side on the basis of the top Y of the respective outer blades 11, are arranged closer to the top Y than the first hair lifting frames 33A.

Therefore, the hair lifting portions 45 of the second hair lifting frames 33B can easily come into contact with the skin surface 37 compared to the case in which the first hair lifting frames 33A and the second hair lifting frames 33B are symmetrically arranged. As a result, the differences in hair lifting ability between the first hair lifting frame 33A and the second hair lifting frame 33B can be reduced so as to lift the body hair up more efficiently. In addition, due to the increase in hair lifting efficiency, it is possible to improve performance of introduction of the lying body hair into the outer blades 11, and enhance the shaving ability of the electric shaver 1.

According to the present embodiment, as shown in FIG. 5, the first and second hair lifting frames 33A and 33B are provided not in the regions where contact pressure with the skin is high (around the top portion 27 of the outer blade 11) but in the regions where contact pressure with the skin is low (both side portions 29 and 29 of the outer blade 11). Therefore, an influence (damage) on the skin surface 37 by the hair lifting frames 33 can be prevented.

Moreover, according to the present embodiment, the frames 32 are composed of the vertical frames 30 extending in the longitudinal direction 23 of the outer blades 11 and the transverse frames 35 extending in the short-side direction 25, in which the hair lifting frames 33 including the hair lifting portions 45 are provided in the vertical frames 30. Thus, the body hair lifted by the hair lifting frames 33 are easily inserted into the blade holes 36 so as to shave the body hair easily.

Further, according to the present embodiment, the hair lifting portions 45 of the hair lifting frames 33 are formed into a tapered shape inclined upward and extending toward the outer surfaces of the outer blades 11 (in the upper direction in the figures). Since the short-side end portions 43 of the hair lifting portions 45 are formed into a tapered shape in cross-section, the hair lifting portions 45 having a simple configuration can be provided. In addition, the tapered shape of the hair lifting portions 45 inclined upward and extending toward the outer surfaces of the outer blades 11 (in the upper direction in the figure) can prevent the body hair at a small hair rising angle from entering the gap between the hair lifting portions 45 and the skin, and can lift the lying body hair up more reliably.

Still further, according to the present embodiment, the longitudinal end portions 61 of the hair lifting frames 33 are formed into an approximately linear shape in cross-section, the bent portions 47 are provided in the longitudinal center portions 63, and the longitudinal end portions 61 located on both sides are respectively connected to the longitudinal center portions 63 via the gently-curved boundaries 65. Due to the gently-curved boundaries 65 connecting the respective longitudinal end portions 61 located on both sides and the longitudinal center portions 63 of the hair lifting frames 33, an influence (damage) on the skin surface 37 caused by the boundaries 65 can be prevented when sliding the outer blades 11 along the skin surface 37.

Although the preferred embodiment has been described above, the present invention is not limited to the foregoing embodiment, and various modifications can be made. For example, although the electric shaver 1 capable of sliding both in one direction and in the opposite direction has been described in the embodiment, it is more preferable to apply the present invention to electrical shavers that have the directional restriction (to slide in a fixed direction).

### REFERENCE SIGNS LIST

1 Electric shaver

3 Shaver main body

11 Outer blade

13 Inner blade

17 First net blade

19 Second net blade

21 Third net blade

32 Frame

33 Hair lifting frame

33A First hair lifting frame

33B Second hair lifting frame

36 Blade hole

37 Skin surface

Y Top

1. An electric shaver, comprising:
a shaver main body;
an outer blade having blade holes defined by frames; and
an inner blade provided inside the outer blade to move relative to the outer blade and cut body hair inserted into the blade holes,
wherein the outer blade is formed into an arc-like shape projecting toward a skin surface and exposed on a top end surface of the shaver main body,
the frames of the outer blade include hair lifting frames provided with hair lifting portions that come into contact with the body hair to lift the body hair from the skin surface when moving on the skin surface,
the hair lifting frames are uniformly formed into an identical shape, and include first hair lifting frames provided on a front side in a traveling direction of the shaver main body and second hair lifting frames provided on a rear side in the traveling direction based on a top portion of the outer blade, and
the second hair lifting frames are arranged closer to the top portion than the firs hair lifting frames.
